(19) United States
(12) Patent Application Publication
(10) Pub. No.: US 2004/0091055 A1
(43) Pub. Date: May 13, 2004

(54) Digital transmission system using non-orthogonal matrices

(76) Inventor: Thomas Holtzman Williams, Longmont, CO (US)

Correspondence Address: THOMAS H. WILLIAMS, 6423 FAIRWAYS DR, LONGMONT, CO, 80503, US

(21) Appl. No.: 10/697,393

(22) Filed: Oct. 30, 2003

Related U.S. Application Data
(60) Provisional application No. 60/422,308, filed on Oct. 30, 2002.

(51) Int. Cl. H04L 27/00

(52) U.S. Cl. 375/259

(57) ABSTRACT

A digital modulation technique that utilizes a spreading matrix to linearly transform an input symbol sequence into a transmit symbol sequence using a two-dimensional transmission matrix. The transmit symbol sequence is filtered, modulated, and transmitted over a channel. At the receiver, a received symbol sequence is captured, demodulated, equalized if needed, and again transformed with a recovery matrix that is an inverse of the spreading matrix that was used at the transmitter. By using an inverse matrix instead of a more conventional transposed matrix, it is possible to construct a matrix from non-orthogonal basis functions. This allows much greater flexibility in determining the properties of a transmitted symbol sequence. If a non-square transmission matrix is used, the number of symbols in the transmit symbol sequence may exceed the number of symbols in the input symbol sequence, creating redundant symbols. The redundant symbols may be used to replace any of the transmit symbols that were damaged by transmission impairments. Alternately, the redundant transmit symbols may be used to reduce the effects of random noise in an output symbol sequence. The transmit symbol sequence may optionally be transformed a second time at the transmitter by an inverse fast Fourier transform (IFTT) prior to transmission, in a technique comparable to OFDM (orthogonal frequency division multiplexing). The second transform process converts time domain symbols into frequency domain symbols. If some of the frequency domain symbols fall into frequency-selective deep channel fades, which are frequently encountered in wireless channels, redundant transmit symbols can be used to insure error-free reception.

### FIELD OF THE INVENTION

The present invention pertains to digital modulation techniques for sending data through wired and wireless channels and specifically to techniques that use non-orthogonal matrices to process a transmitted signal. This patent application is a continuation of provisional U.S. patent application 60/422,308 filed on Oct. 30, 2002.

Bibliography: “Inverse Matrix Modulation with Over-Determined Matrices” by Thomas H. Williams, World Wireless Congress, May 27-30, 2003, published on CD-ROM by the Delson Group

### DESCRIPTION OF THE BACKGROUND

The most basic method used to transmit digital information over a band-limited channel is pulse amplitude modulation (PAM). PAM inputs a stream of data to be transmitted and forms the stream into variable-amplitude periodic pulses, which are symbols. The periodic stream of symbols is low pass filtered with a Nyquist filter to limit the bandwidth without creating inter-symbol interference (ISI) and sent to a modulator. After modulation, the signal is up-converted for transmission over an RF channel. Several types of linear modulators can be used, resulting in a vestigial sideband signal (VSB), a quadrature amplitude modulated (QAM) signal, or a single sideband signal (SSB) transmission. However, improvements can be gained by performing transforms on the symbols before transmission to gain an advantage against some types of channel impairments. Two well known transform-based modulation techniques are direct sequence spread spectrum (DSSS) and orthogonal frequency division multiplexing (OFDM). A third transform-based modulation technique is wavelet modulation.

All three transform modulation techniques may be viewed as matrix multiplication operations at the transmitter, where spreading matrices are comprised of linearly independent basis functions with a property of orthogonality. At the receiver, a signal de-spreading is accomplished by multiplying a received symbol sequence by a transpose of the spreading matrix.

A DSSS matrix may comprised of rows of pseudo-noise (PN) sequences which are orthogonal to each other.

The rows of an OFDM matrix may be formed from sine and cosine functions that have an integer number of cycles. Sine and cosine waves with integer numbers of cycles are orthogonal to each other. In practice, an inverse fast Fourier transform (IFFT) is normally used instead of a matrix multiply because it is computationally easier. A wavelet matrix may be formed from rows that are basis functions called wavelets.

Pulse amplitude modulation, DSSS, OFDM, and wavelet-transformed signals may all be transmitted as baseband signals through baseband channels, or modulated and unconverted for transmission over a RF or microwave channel. Several types of linear modulators can be used, resulting in a vestigial sideband signal (VSB), a quadrature amplitude modulated (QAM) signal, or a single sideband signal (SSB) transmission.

One disadvantage of broadcasting spread signals that are formed by orthogonal basis function is security. Because these signals are comprised of orthogonal basis functions that are selected from a fixed alphabet of basis functions, it is easy for an unintended listener to read the transmission. Another disadvantage of using orthogonal signal sets is a loss of orthogonality between basis functions if a transmission process corrupts one or more of the symbols. For example, the transmission corruption may be caused by deep frequency-selective fades in the frequency domain, or bursts of impulsive noise in the time domain.

These and other limitations of the prior art are overcome in the present invention.

### SUMMARY OF THE INVENTION

The present invention overcomes the disadvantages and limitations of the prior art by providing a system and method for signal transmission comprised of an input symbol sequence, a two-dimensional transmission matrix comprised of non-orthogonal rows for converting the input symbol sequence into a transmit symbol sequence, a signal path, a received symbol sequence, a recovery matrix which is an inverse of the transmission matrix, and an output symbol sequence.

Additionally, the present invention may be comprised of a two-dimensional transmission matrix that is over-determined, creating a transmit symbol sequence, which contains more symbols than are in the input symbol sequence. The additional (excess) symbols are redundant symbols. Corrupted symbols in the received symbol sequence may be discarded, and replaced by redundant uncorrupted symbols. A recovery matrix is formed by computing an inverse of a transmission matrix that has been modified by dropping rows corresponding to corrupted terms in the received symbol sequence.

The present invention may employ a transmission that performs both spreading and frequency transforms, thereby creating spread frequency domain symbols.

### SUMMARY OF THE FIGURES

FIG. 1 is a block diagram of a prior art signal flow using an orthogonal row matrix.

FIG. 2 is a block diagram of a time domain inverse matrix modulation (TDIMM) system using a square non-orthogonal row transmission matrix.

FIG. 3 is a TDIMM numerical multiplication example using a non-orthogonal row over-determined non-square matrix.

FIG. 4 is a block diagram of a TDIMM signal flow associated with a non-orthogonal row over-determined non-square matrix.

FIG. 5 is a block diagram of signal flow of frequency domain inverse matrix modulation (FDIMM).

### DESCRIPTION OF THE DRAWINGS

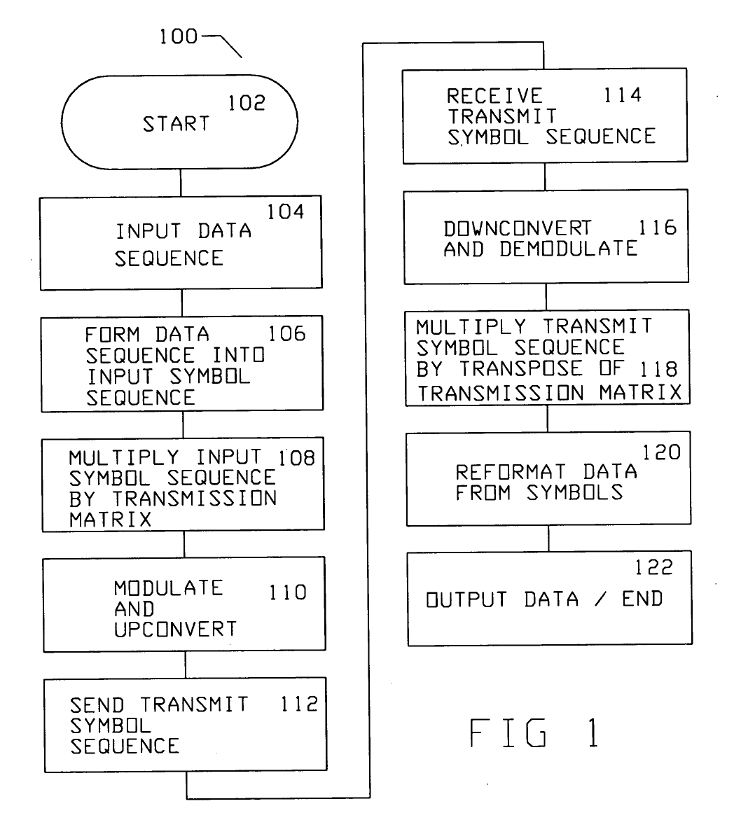

Discussion FIG. 1

FIG. 1 is a prior art block diagram 100 of a signal flow for a transmission system that spreads signals using a matrix. The system could be DSSS, OFDM or wavelet based, provided that the rows of the transmission matrix are orthogonal to each other. The signal flow starts at step 102. At step 104 a data sequence to be transmitted is loaded. The data sequence may, for example, be Internet data or a voice transmission. The data sequence may be a single block of data or a block of data that is part of a continuous stream. At step 106 a data sequence is formed into an input symbol sequence. The more possible states a symbol can assume, the more bits of information that can be represented. For example, if the symbols can assume any of four states, each symbol can represent two bits of data. At step 108 a matrix that contains orthogonal, or nearly orthogonal rows multiplies the input symbol sequence to create a transmit symbol sequence. The matrix may be square, but it is not a requirement.

The well-known orthogonality property between rows implies that:

$$\begin{matrix}{\sum }_{n = 1}^{n = m} c ( x , n ) \cdot c ( y , n ) = 0 for any row x that is not equal to row y & ( 1 ) \\ {\sum }_{n = 1}^{n = m} c ( x , n ) \cdot c ( y , n ) = {K}_{x , y} for any row x that is equal to row y & ( 2 )\end{matrix}$$

where c(row#, column#) are terms comprising the matrix, n is the column index, and m is the total number of columns, and K_{x,y} is a constant that depends on the row numbers chosen.

In step 110 the transmit symbol sequence is modulated and up-converted in frequency for transmission. In step 112 the transmit symbol sequence is transmitted over a signal path, and received in step 114. In step 116 the received symbol sequence is down-converted and demodulated in a reverse of step 110. If any adjustments are needed to the received symbol sequence, such as equalization or fine timing recovery, they may also be done at step 116. At step 118 a matrix that is the transpose of the matrix that was used at step 108 multiplies the received symbol sequence to create an output symbol sequence. At step 120, assuming that there were no transmission errors, an output data sequence is reconstructed from an output symbol sequence, which is identical to the input data sequence. At step 122 the data is delivered and the end is reached.

Frequently, forward error correction (FEC) is used in conjunction with the spreading to reduce the error rate in the output symbol sequence.

A transpose of a matrix is accomplished by simply interchanging rows and columns, so that row one becomes column one, row two becomes column two, and so forth. In the DSSS case, the matrix multiplication process is referred to as spreading, and the matrix multiplication process by the transpose matrix is called de-spreading. Although OFDM transmissions can be created using matrices, it is more computationally efficient to use an inverse fast Fourier transform (IFFT). Matrix algebra is well known in the art. “Numerical Recipes in C” by Williams H. Press et. al. is a useful book with code for many matrix operations. Matlab® is a quick and user-friendly computer program that can readily manipulate matrices. “Mastering Matlab 6” by Hanselman and Littlefield is a useful book to accompany the Matlab program.

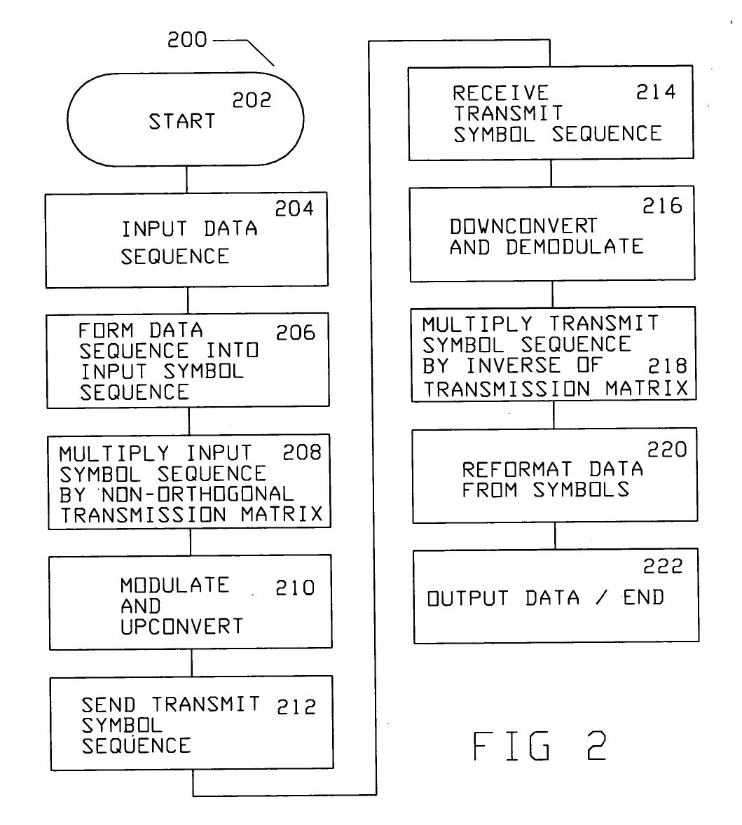

Discussion FIG. 2

FIG. 2 is a block diagram 200 of the present invention. An important difference between this block diagram and the prior art bock diagram of FIG. 1 is that a matrix with non-orthogonal rows is used at the transmit site, and an inverse of the non-orthogonal matrix is used at the receive site. An inverse matrix can be computed by several methods, including the Gauss-Jordan elimination method. When a matrix is multiplied by its inverse an identity matrix results.

The signal flow starts at step 202. At step 204 a data sequence to be transmitted is loaded. At step 206 an input symbol sequence is formed from the data sequence. At step 208 a matrix that contains non-orthogonal rows multiplies the input symbol sequence to create a transmit symbol sequence. For example, a random number generator could choose the terms of this matrix. In step 210 the transmit symbol sequence is modulated and up-converted in frequency for transmission. In step 212 the transmit symbol sequence is transmitted over a signal path with the transmit symbols sent sequentially in time, and received in step 214. In step 216 a received symbol sequence is down-converted and demodulated in a reverse of step 210. Step 216 could also perform any needed equalization or timing adjustment. At step 218 a matrix that is the inverse of the matrix that was used at step 208 multiplies the received symbol sequence to create an output symbol sequence. At step 220, assuming that there were no transmission errors, an output data sequence is reconstructed from an output symbol sequence, which is identical to the input data sequence. At a step 222 the output data sequence is delivered and the end is reached.

An inverse matrix may be computed from a square matrix if the matrix is not singular. A non-singular matrix may be viewed as a system of N equations with N unknowns. The inverse of the matrix may be viewed as the solution of the equations.

A matrix could be chosen using a random number generator. A measure of how close the matrix is to being singular can be computed as the condition number of the matrix. A condition number of 1.0 is ideal, while a very large value indicates a singular matrix. Orthogonal matrices typically return a value of 1.0, but this novel technique does not require that a transmission matrix be orthogonal, only that an inverse can be computed. Note that for a square matrix with orthogonal rows, its transpose matrix is equal to its inverse matrix.

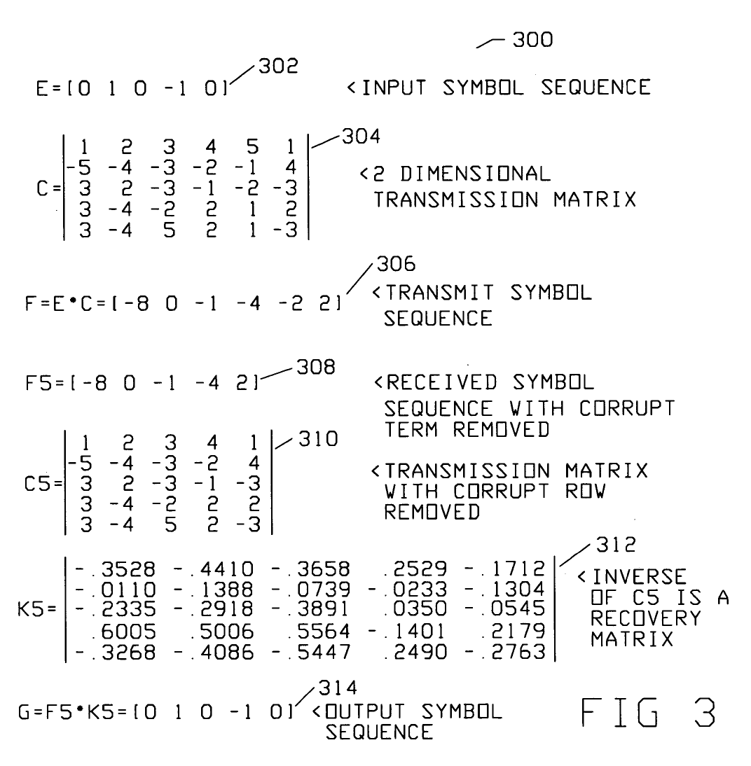

Discussion FIG. 3

It is also possible to have a system of M equations with N unknowns, where M>N. A matrix representing such a system of equations with more equations than unknowns is called “over-determined” and is rectangular, not square. Such a system of equations may be solved for all of the unknowns, even if some of the equations are not utilized.

FIG. 3 is a numeric matrix multiplication example 300 using a non-orthogonal over-determined matrix, which can be referred to as a “mother” matrix. An input symbol sequence 302 with 5 terms has been formed from data. A two dimensional mother transmission matrix 304 is comprised of non-orthogonal rows. Note that the transmission matrix 304 has 6 columns but only 5 rows, so it is an over-determined matrix. A transmit symbol sequence 306 is created by multiplying the input symbol sequence 302 by the transmission matrix 304. The use of an over-determined transmission matrix creates 6 terms in the transmit symbol sequence 306 from only 5 terms in the input symbol sequence 302. This 6-term transmit symbol sequence is sent over a signal path. Assume, for example, that the 5th symbol (the term with a value of −2) has been corrupted in transmission, and has therefore been omitted from a truncated received symbol sequence 308. The original input symbol sequence may still be recovered by multiplying the truncated received symbol sequence by a daughter inverse recovery matrix. Dropping the row of the mother transmission matrix 304 that corresponds to the corrupt term in the truncated received symbol sequence creates the daughter matrix. If the 5^{th} row, corresponding to the 5^{th} corrupt received term, is removed from the transmission matrix 304, a daughter transmission matrix with the corrupt row removed 310 is created. It has been labeled C5 to designate that the 5^{th} column is removed. If the C5 inverse is computed, a recovery matrix 312 is found. The output symbol sequence 314 is computed without error by multiplying the truncated received symbol sequence 308 by the inverse of the truncated daughter transmission matrix 312.

The selection of a non-orthogonal over-determined transmission matrix requires that all possible daughter matrices have an inverse.

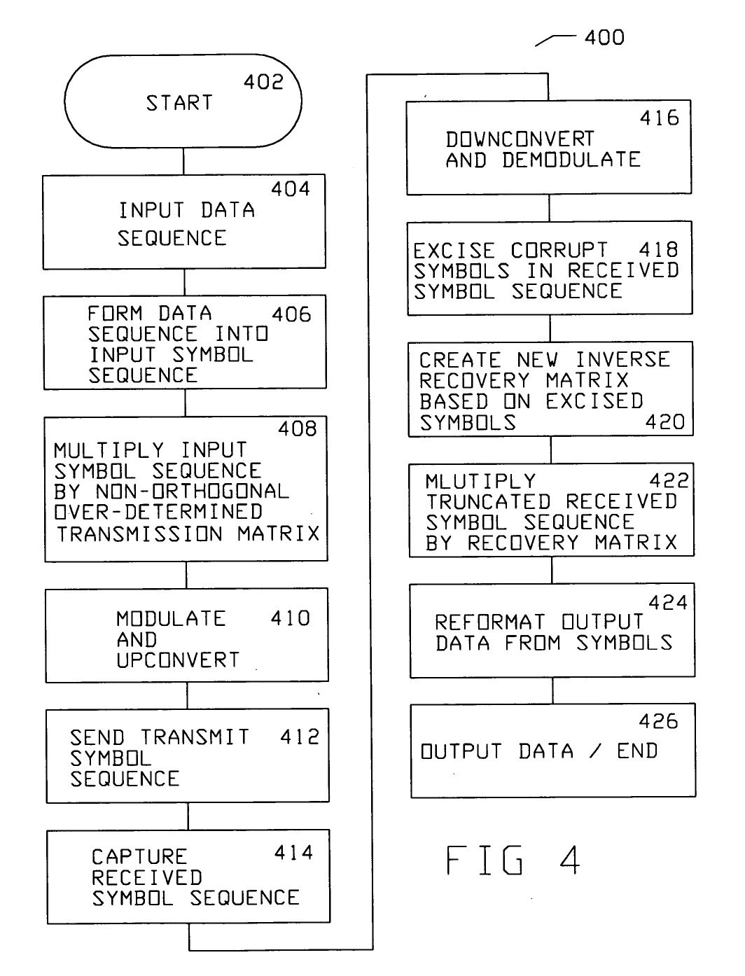

Discussion FIG. 4

FIG. 4 is another block diagram 400 of the present invention. Block diagram 400 corresponds to the numerical example of FIG. 3. The signal flow starts at step 402. At step 404 an input data sequence to be transmitted is loaded. At step 406 a input symbol sequence is formed from the input data sequence. At step 408 a matrix that contains an over-determined non-orthogonal mother matrix multiplies the input symbol sequence to create a transmit symbol sequence. In step 410 the transmit symbol sequence is modulated and up-converted in frequency for transmission. In step 412 the transmit symbol sequence is transmitted over a signal path with the transmit symbols sent sequentially in time, and received in step 414. In step 416 a received symbol sequence is down-converted and demodulated in a reverse of step 410. If necessary, equalization and timing recovery can also occur in step 416. At step 418 the corrupted symbols are excised from the received symbol sequence, creating a truncated received symbol sequence. The decision to excise a symbol could be based, for example, on the timing of a power surge, indicating impulsive noise interference with that symbol. At step 420, the columns that correspond to the corrupted terms in the received symbol sequence are removed from the mother matrix creating a daughter matrix. Also at step 420, an inverse recovery matrix is created from the daughter matrix. At step 422 the daughter recovery matrix multiplies the truncated received symbol sequence to create an output symbol sequence. At step 424 the symbols are delivered as data. At a step 426 the output data sequence is delivered and the end is reached.

Should none of the symbols in the transmit symbol sequence be excessively corrupted relative to the others in the transmission process, all received symbols can all be used by using a recovery matrix that is a pseudo-inverse of the transmission matrix. Using the energy from all symbols could be an advantage when the main channel impairment is random, or Gaussian, noise.

The block diagram of FIG. 4 can be improved by interleaving symbols from multiple transmit symbol sequences, thereby improving the system's ability to withstand long duration bursts of impulsive energy. Interleaving is a well-known technique in the art and is accomplished by writing the symbols by rows and reading it out by columns. Interleaving could be done at step 406 and de-interleaving could be done at step 418 before excision is done.

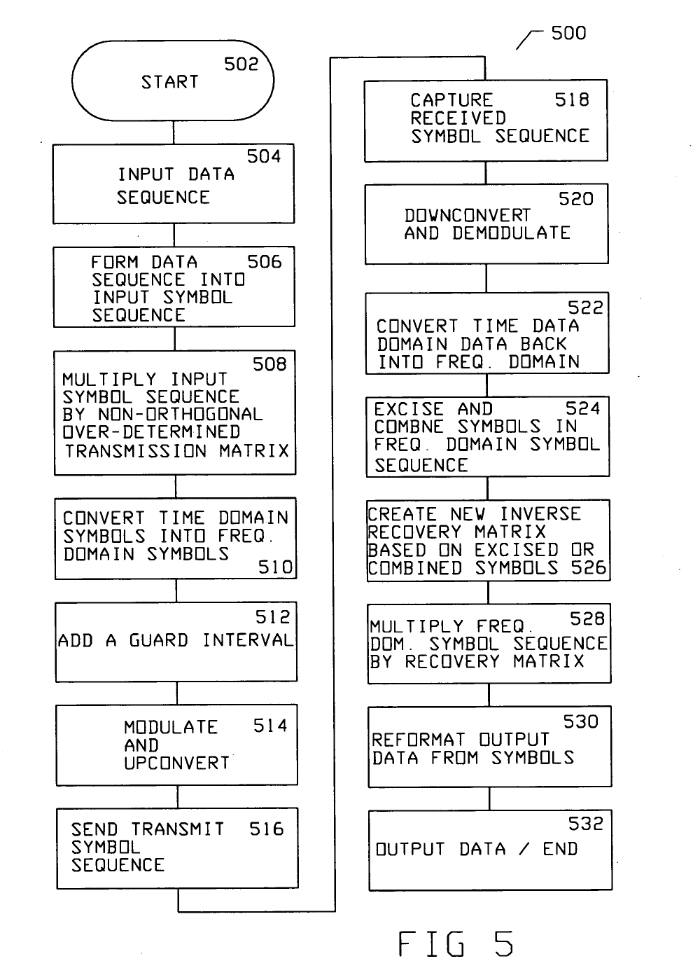

Discussion FIG. 5

The discussion of FIG. 2 indicated that a random number generator could be used to make a transmission matrix, provided that it was checked to verify that it was not close to being singular. However, there are an unlimited number of possible matrices with non-orthogonal basis functions that can be used to make signals with desirable transmission properties. The transmission method disclosed in FIG. 2 and FIG. 4 transmitted the transmit symbol sequence sequentially in time. Thus, the transmission method can be called “Time Domain Inverse Matrix Modulation” (TDIMM). TDIMM is a good transmission method when the impulsive noise bursts in the time domain corrupt symbols in the received symbol sequence.

It is also possible to transform a transmit symbol sequence a second time to place the symbols into the frequency domain. This can be accomplished by multiplying the transmit symbol sequence by a matrix that performs a discrete inverse Fourier transform (DIFT). Another equivalent method to do the same time-to-frequency operation would be to do an IFFT. Thus, the transmit symbol sequence may be transmitted in the frequency domain and the modulation technique may be called “Frequency Domain Inverse Matrix Modulation” (FDIMM).

One of the severe problems with wireless signal paths that are not line-of-sight is multipath distortion. Deep frequency-selective channel fades are created by signals that add out of phase. FDIMM is a good modulation technique to use for these signal paths since frequency domain symbols located in deep fades can be eliminated, while frequency domain symbols that are weak can be combined to produce a single stronger frequency domain symbol.

FIG. 5 is another block diagram 500 of the present invention. The signal flow starts at step 502. At step 504 a data sequence to be transmitted is loaded. At step 506 an input symbol sequence is formed from the data sequence. At step 508 a non-orthogonal mother matrix multiplies the input symbol sequence to create an intermediate transmit symbol sequence. The matrix may be over-determined, creating more output symbols than input symbols. In step 510 the intermediate transmit symbol sequence is converted into the frequency domain using another matrix multiply that performs the DIFT. The equivalent result could be achieved with an IFFT operation. At step 512 a guard interval (or cyclic extension) is optionally added to the transmission to simplify equalization in the presence of channel echoes. At step 514 the transmit symbol sequence is modulated and up-converted in frequency for transmission with the transmit symbols sent sequentially in frequency. In step 516 the transmit symbol sequence is transmitted over a signal path. In step 518 a received symbol sequence is captured. In step 520 the received symbol sequence is down-converted and demodulated in a reverse of step 514. If necessary, equalization and timing recovery can also be accomplished in step 520. At step 522 the data are converted from time domain symbols into frequency domain symbols. The guard interval is discarded. At step 524 the badly corrupted symbols are excised. A determination of which symbols to discard can be made by analyzing a training signal passed through the channel to discover frequency-selective fades. Additionally, mildly corrupted symbols may be combined to reduce the affects of noise by averaging. At step 526, removing the columns from the mother matrix that correspond to the corrupted terms in the received symbol sequence creates a daughter recovery matrix. If terms have been combined to reduce noise in the received symbol sequence, the corresponding rows are combined in the mother matrix to make a daughter matrix. Also at step 526, a recovery matrix is created from the daughter matrix by computing the inverse matrix. At step 528 the recovery matrix multiplies the received excised/combined symbol sequence to create an output symbol sequence. At step 530 the output data sequence is made from the output symbol sequence. At step 532 the output data sequence is delivered and the end is reached.

If the rank of the matrices used in the two matrix multiplications is the same, the two matrices can be combined to eliminate one matrix multiply.

Another improvement can be made to the block diagram of FIG. 5 by using interleaving to provide additional protection from deep channel fades, which typically attenuate several adjacent frequency domain symbols. Frequency domain symbols are also known as harmonic carriers (HCs). Interleaving could be performed at step 506 after the symbols were formed, and de-interleaving could be performed at step 524 prior to symbol excision.

Discussion of Over-Determined Pulse Amplitude Modulation

Conventional pulse amplitude modulation may also be viewed as a modulation technique using an identity matrix. An identity matrix is well known in the art and is comprised of all zeroes except for a diagonal line of ones. When an identity matrix multiplies an input symbol sequence, the resulting transmit symbol sequence is identical to the original input symbol sequence. An identity matrix is comprised of rows that are orthogonal basis functions. An identity matrix can be modified according to the present invention by adding one or more additional columns comprised of energy terms.

An example of a possible transmission matrix created from an extension of an identity matrix is:

$$\begin{matrix}1 & 0 & 0 & 0 & 0 & 0.2 \\ 0 & 1 & 0 & 0 & 0 & 0.2 \\ 0 & 0 & 1 & 0 & 0 & 0.2 \\ 0 & 0 & 0 & 1 & 0 & 0.2 \\ 0 & 0 & 0 & 0 & 1 & 0.2\end{matrix}$$

Note that the above transmission matrix is non-orthogonal and any resulting symbol in the transmit symbol sequence can be discarded.

Other variations to the present invention allow the over-determined system of equations to be solved by the least squares method or by multiplication by a pseudo-inverse matrix. Both least squares solutions and pseudo-inverse matrices are well known in the art.

Although the description above contains many specificities, these should not be construed as limiting the scope of the invention, but as merely providing illustrations of some of the presently preferred embodiments of this invention.

For Example:

1. Forward error correction and interleaving may be used along with the non-orthogonal spreading matrix to reduce error rates.

2. The transmission system may be used either at baseband or combined with a modulation technique for use on a radio frequency channel.

3. The technique can be used for wired or wireless channels.

4. The implementation may contain an arbitrary mix of hardware, software, and firmware.

5. Hardware may be an application specific integrated circuit (ASIC), programmable logic device, or discrete logic. Likewise, the implementation may use varying amounts of analog or digital circuitry.

6. The size of the matrix can be adjusted as desired

7. The matrix to be used can be downloaded to a transmitter to allow a custom transmission matrix to be used for best performance with current channel impairments or to foil an unintentional listener.

8. The transmission matrix can vary between transmit symbol sequences to foil an unintentional listener.

9. Instead of using the recovery matrix, the well-known least mean squares (LMS) algorithm may be used to recover the output symbol sequence from the received symbol sequence. This technique is useful when random noise is an impairment affecting all symbols.

10. Multiple transmitters transmitting simultaneously can create a composite received symbol sequence. Accurate timing synchronization and power adjustment is required for each of the separate transmitters.

11. Transmission matrices can be created that have energy surges or nulls in either the time domain or the frequency domain to overcome channel impairments.

12. Intentional clipping can be done on a transmit symbol sequence to prevent overloading an amplifier. The intentionally-clipped symbol can be discarded at the receiver according to the present invention.

13. Any conceivable transmission matrix can be used with non-orthogonal basis functions provided that a non-singular inverse exists.

14. The transmission matrix can be over-determined by any number of columns.

What I claim is:

1. A digital transmission system comprising:
a. a transmitter transmitting a transmit symbol sequence that has been created by multiplying an input symbol sequence by a transmission matrix, said transmission matrix being comprised of non-orthogonal basis functions;
b. a signal path,
c. a receiver receiving a received symbol sequence, and
d. a processing element multiplying the received symbol sequence by a recovery matrix, whereby an output symbol sequence is produced.

2. A digital transmission system according to claim 1, wherein the transmission matrix is square and the recovery matrix is the inverse of the transmission matrix.

3. A digital transmission system comprising:
a. a transmitter transmitting a transmit symbol sequence that has been created by multiplying an input symbol sequence by an over-determined transmission matrix, said transmission matrix being comprised of non-orthogonal basis functions;
b. a signal path
c. a receiver receiving a received symbol sequence, and
d. a processing element multiplying the received symbol sequence by a recovery matrix, whereby an output symbol sequence is produced.

4. A digital transmission system according to claim 3, wherein the recovery matrix is a pseudo-inverse of the transmission matrix.

5. A digital transmission system according to claim 3, wherein the processing element removes redundant symbols in the received symbol sequence and a recovery matrix is created from an inverse of the transmission matrix with the corresponding columns removed.

6. A digital transmission system comprising:
a. a transmitter transmitting a transmit symbol sequence that has been created by multiplying an input symbol sequence by a transmission matrix comprised of non-orthogonal basis functions and performing an inverse fast Fourier transform in the result;
b. a signal path,
c. receiver receiving a received symbol sequence, and
d. a processing element multiplying the received symbol sequence by a recovery matrix and performing a fast Fourier transform, whereby an output symbol sequence is produced.

7. A digital transmission system according to claim 6, wherein a guard interval is added to the transmit symbol sequence.

8. A digital transmission system according to claim 6, wherein the processing element removes corrupt symbols and a recovery matrix is created from an inverse of the transmission matrix with the corresponding columns removed.
